(19) United States
(12) Patent Application Publication
(10) Pub. No.: US 2010/0109282 A1
(43) Pub. Date: May 6, 2010

(54) Bicycle suspension systems

(76) Inventor: David Weagle, Edgartown, MA (US)

Correspondence Address: STAHL LAW FIRM, 2 MEADOWSWEET LANE, SAN CARLOS, CA, 94070, US

(21) Appl. No.: 12/584,996

(22) Filed: Sep. 15, 2009

Related U.S. Application Data
(60) Provisional application No. 61/192,219, filed on Sep. 16, 2008.

(51) Int. Cl. B62K 25/10

(52) U.S. Cl. 280/284

(57) ABSTRACT

The invention relates to suspension systems comprising, in certain embodiments, a linkage arrangement including a shock link, wheel link, rate link, and first shock pivot, positioned so that a first shock pivot is moved in a downward and rearward direction as the suspension is compressed, while said wheel link and shock link rotate in opposite directions, and so that a leverage ratio is tactically controlled through said linkage arrangement.

This application claims the benefit of U.S. Provisional Application No. 61/192,219, filed Sep. 16, 2008, which is incorporated herein by reference in its entirety.

### 1.0 FIELD OF THE INVENTION

This invention relates to bicycle suspension systems featuring a low center of mass, tunable leverage ratios and wheel rates.

### 2.0 BACKGROUND

Bicycles are used for various purposes, including transportation and leisure. These bicycles are designed to use a power source to drive through a power transmission system to a wheel or wheels, which transfers rotary motion to the ground via tractive force between a wheel or wheels and the ground. Bicycles are also used to traverse even terrain like paved streets, and uneven terrain like off-road dirt trails. Off road trails are generally bumpier and allow for less wheel traction than paved roads. A bumpier terrain is best navigated with a bicycle that has a suspension system. A suspension system in a bicycle is aimed to provide a smoother ride for an operator or rider, and increase wheel traction over varied terrain. As a suspension system is compressed it allows a wheel to move out of the way of bumps in varied terrain. Bicycle suspension systems for the front wheel and for the back wheel are available. A rear suspension typically includes at least one structural suspension member, and a spring damper unit that is typically referred to as a shock absorber or shock. The shock absorber is typically attached to a structural suspension member, and another member in a way that allows the shock absorber to be compressed or extended as the suspension is compressed. Through this attachment, as the suspension is compressed, force resisting suspension compression increases. The shock absorber's total compression or extension distance is typically less than the wheel's compression distance. The ratio of wheel compression distance to shock compression or extension distance is called leverage ratio or leverage ratio. The spring force output at the rear wheel center is called wheel rate. Bicycles have a center of mass. A center off mass is defined by the location of the weight s of different components in a bicycle frame. A center of mass is a point on the bicycle frame at which if supported, gravity will produce no turning moments. Bicycles have means of powered acceleration and deceleration. Powered acceleration can be achieved through human power rotating a wheel through a mechanical arrangement. Deceleration can be achieved through the use of a braking system that mechanically impedes rotation of a wheel. Bicycle racing is a popular pastime. Some bicycle racing events, called downhill events, include timed runs down a mountain where the rider to traverse a set distance in the least amount of time is declared the winner. These downhill events take place on very bumpy terrain, with tight corners and jumps that must be navigated by rider and bicycle. A specifically tuned leverage ratio can help a bicycle maintain greater traction over varied terrain. A lower center of mass of a bicycle frame can help to allow the rider greater control over varied terrain.

One undesirable effect of suspension systems is that suspension components are typically heavy, and suspension layouts require that shock absorbers be placed high in the chassis, causing a high center of mass and making control of the bicycle more difficult. Another undesirable effect of suspension is that unwanted responses or suspension compression or extension while traversing bumps can be present if wheel rate is too high or too low at any point in the suspension travel.

A need exists for suspension systems that can provide a lower center of mass and a tunable leverage ratio and wheel rate. The present invention provides new suspension systems for bicycles that can provide lower centers of mass, tunable leverage ratios and wheel rates.

### 3.0 SUMMARY OF THE INVENTION

The current invention relates to new suspension systems for bicycles, for example, two wheel bicycles, four wheel human powered vehicles, front wheel suspension bicycles, driven wheel suspension bicycles, and any other kind of bicycle with a suspension system. In certain embodiments of the invention, a suspension system of the invention can support a wheel using a link arrangement to control suspension movement and the suspension's reaction to bumps by manipulating leverage rate, while positioning a shock absorber low in a frame.

Suspension systems of the invention are useful for a variety of bicycles and preferably in human powered bicycles. A specifically tuned leverage ratio can help a bicycle maintain greater traction over varied terrain. A lower center of mass of a bicycle frame can help to allow the rider greater control over varied terrain. The need for a suspension system that can provide a lower center of mass and a tunable leverage ratio and wheel rate has therefore become more pressing. The present invention provides suspension system designs for bicycles that provide a lower center of mass and a tunable leverage ratio and wheel rate.

Certain embodiments of the invention can comprise a wheel suspension system where a wheel link supports a wheel rotation axis and a wheel link floating pivot so that the wheel rotation axis and wheel link floating pivot rotate about a wheel link fixed pivot as the suspension is compressed. When the suspension is compressed and the bicycle is viewed from the right side, the wheel link rotates in a clockwise direction, and in certain embodiments, the wheel rotation axis moves in an upward or generally upward direction, while the wheel link floating pivot moves in a downward or generally downward direction.

Certain embodiments of the invention can comprise a shock absorber. A shock absorber, in certain embodiments, may be a damper, a spring, a compression gas spring, a leaf spring, a coil spring, or a fluid. In certain other embodiments, a shock absorber is mounted so that it is able to respond to movement of a rear wheel. In certain embodiments, a shock absorber is mounted to a shock link. In certain embodiments, a shock absorber is mounted to a rate link. In certain embodiments, a shock absorber is mounted to a wheel link. In certain embodiments, a shock absorber is mounted to a shock link and/or a wheel link in a pivotal manner, and preferably so that a force that compresses or extends the shock absorber is transmitted through a wheel link or a shock link. In certain embodiments, a shock absorber is mounted to a shock link and/or a frame in a pivotal manner, and preferably so that a force that compresses or extends the shock absorber is transmitted through a frame or a shock link. In certain embodiments, a shock absorber is mounted to a shock link and/or a frame support in a pivotal manner, and preferably so that a force that compresses or extends the shock absorber is transmitted through a frame support or a shock link.

Leverage ratios of the current invention are designed to achieve a desired force output at a wheel. In certain embodiments a leverage ratio curve can be broken down into three equal parts in relation to wheel compression distance or vertical wheel travel, a beginning ⅓ (third), a middle ⅓, and an end ⅓. In certain embodiments, a beginning ⅓ can comprise a positive slope, zero slope, and or a negative slope. In certain embodiments, a middle ⅓ can comprise a positive slope, zero slope, and or a negative slope. In certain embodiments, an end ⅓ can comprise a positive slope, zero slope, and or a negative slope.

### 4.0 BRIEF DESCRIPTION OF THE DRAWINGS

FIG. 1A shows a diagrammatical side view of a bicycle using a wheel suspension system that according to certain embodiments of the current invention. The bicycle is shown with the wheel suspension system in an uncompressed state.

FIG. 1B shows a diagrammatical side view of a bicycle using a wheel suspension system that according to certain embodiments of the current invention. The bicycle is shown with the wheel suspension system in a compressed state.

FIG. 2A shows a diagrammatical side view of a bicycle using a wheel suspension system that according to certain embodiments of the current invention. The bicycle is shown with the wheel suspension system in an uncompressed state.

FIG. 2B shows a diagrammatical side view of a bicycle using a wheel suspension system that according to certain embodiments of the current invention. The bicycle is shown with the wheel suspension system in a compressed state.

FIG. 3 shows a leverage ratio curve graph according to certain embodiments of the invention.

FIG. 4 shows a leverage ratio curve graph according to certain embodiments of the invention.

FIG. 5 shows a leverage ratio curve graph according to certain embodiments of the invention.

FIG. 6 shows a leverage ratio curve graph according to certain embodiments of the invention.

FIG. 7 shows a leverage ratio curve graph according to certain embodiments of the invention.

### 5.0 DETAILED DESCRIPTION

Bicycles must be accelerated against their environment to propel an operator or rider across terrain. In order to accelerate these bicycles, a certain amount of energy must be exerted and transformed into rotary motion at a wheel or plurality of wheels. Suspended wheeled bicycle energy conversion types are widely varied. Some bicycles like bicycles, tricycles, and pedal cars use converted human energy as the drive unit. Almost all bicycle types use some sort of rotary motion transmission system to transfer rotational force from a drive unit to a wheel or plurality of wheels. A simple bicycle uses a chain or belt to transfer power from a drive unit to a wheel. These chain or belt drive transmissions typically use one sprocket in the front which is coupled to a drive system and one sprocket in the rear which is coupled to a wheel.

More complex bicycles, and all terrain bicycles use a shaft drive system to transfer power from a drive system to a driven wheel or wheels. These shaft drive systems transfer power through a rotating shaft that is usually reasonably perpendicular to the driven wheel spinning axis, with power transferred to the driven wheel via a bevel, spiral bevel, hypoid, worm gear drivetrain, or some other means. These single sprocket chain and belt, and shaft driven bicycles can use a direct driven single speed arrangement, where drive unit output shaft speed and torque is transferred to the driven wheel at a constant unchanging ratio. These single sprocket chain and belt, and shaft driven bicycles can also use a commonly found multi speed arrangement, where drive unit output shaft speed and torque is transferred to the driven wheel at a variable ratio through operator selected or automatically selected ratio changing mechanisms.

A bicycle with a more advanced design includes gear changing systems that have clusters of selectable front chainrings and rear sprockets. These gear changing systems give the bicycle rider a selectable mechanical advantage for use during powered acceleration. The mechanical advantage selection, allows a rider spinning a front sprocket cluster via crank arms, to attain lower revolution speed and higher torque values, or conversely, higher revolution speed and lower torque values at a driven wheel.

A bicycle with a suspension system can be designed to provide a smoother ride for an operator or rider, and increase wheel traction over varied terrain. A bicycle with a suspension system can comprise a frame, a shock absorber, a rear suspension member, which is pivotally attached to said frame so that the rear suspension member can compress and rotate around a pivot axis or a plurality of pivot axis. As a suspension system is compressed it allows a wheel to move out of the way of bumps in varied terrain. A rear suspension includes a spring damper unit that is typically referred to as a shock absorber or shock. The shock absorber is pivotally attached to a rear suspension member in a way that allows the shock absorber to be compressed or extended as the suspension is compressed. Through this attachment, as the suspension is compressed, force resisting suspension compression increases. The shock absorber's total compression or extension distance is typically less than the wheel's compression distance. The ratio of wheel compression distance to shock compression or extension distance is called leverage ratio or leverage ratio. The spring force output at the rear wheel center is called wheel rate. Another undesirable effect of suspension is that unwanted responses or suspension compression or extension while traversing bumps can be present if wheel rate is too high or too low at any point in the suspension travel.

The current invention, in certain embodiments, is directed at suspension systems for bicycles that can control suspension movement through tactical leverage ratio and wheel rate change. Suspension systems of the current invention are useful for a large variety of bicycles, including, but not limited to, human powered bicycles, off road use bicycles with long displacement suspension, high efficiency road going bicycles, and other bicycles.

Bicycles have a center of mass. A center off mass is defined by the location of the weight s of different components in a bicycle frame. A center of mass is a point on the bicycle frame at which if supported, gravity will produce no turning moments. A specifically tuned leverage ratio can help a bicycle maintain greater traction over varied terrain. A lower center of mass of a bicycle frame can help to allow the rider greater control over varied terrain.

One undesirable effect of suspension systems is that suspension components are typically heavy, and suspension layouts require that shock absorbers be placed high in the chassis, causing a high center of mass and making control of the bicycle more difficult.

A bicycle suspension system isolates a bicycle chassis from forces imparted on the bicycle when traversing terrain by allowing the bicycle's ground contact points to move away from impacts at the terrain level and in relation to the bicycle chassis by a compressible suspension movement. The compressible suspension movement that isolates a chassis from these impacts is called suspension displacement or suspension travel. Compressible suspension travel has a beginning point where the suspension is in a completely uncompressed state (the suspension is uncompressed), and an ending point of displacement, where the suspension is in a completely compressed state (the suspension is fully compressed). Suspension travel displacement is measured in a direction parallel to and against gravity. As a suspension system using certain embodiments the invention is compressed, a shock absorber is compressed. As the shock absorber is compressed, the force output from the unit rises. Pivots of a suspension system of the invention are named after a component that connects with the pivot. A pivot may be fixed or floating. A fixed pivot maintains a position relative to the frame of the bicycle when the suspension is compressed. A floating pivot changes its position relative to the frame of the bicycle when the suspension is compressed. A suspended wheel has a compressible wheel suspension travel distance that features a beginning travel point where the suspension is completely uncompressed to a point where no further suspension extension can take place, and an end travel point where a suspension is completely compressed to a point where no further suspension compression can take place. In certain embodiments, at the beginning of the wheel suspension travel distance, when the suspension is in a completely uncompressed state, and using a compressible shock absorber, the shock absorber is in a state of least compression, and the suspension is easily compressed. As the suspended wheel moves compressively, shock absorber force at the wheel, otherwise known as wheel rate, changes in relation to shock absorber force multiplied by a leverage ratio, where a leverage ratio is the ratio of compressive wheel travel change divided by shock absorber length change over a given vertical wheel travel distance. In certain embodiments, at the beginning of the wheel suspension travel distance, when the suspension is in a completely uncompressed state, and using an extensible shock absorber, the shock absorber is in a state of least extension, and the suspension is easily compressed. As the suspended wheel moves compressively, shock absorber force at the wheel, otherwise known as wheel rate, changes in relation to shock absorber force multiplied by a leverage ratio, where a leverage ratio is the ratio of compressive wheel travel change divided by shock absorber length change over a given vertical wheel travel distance.

### 5.1 The Drawings Illustrate Examples of Certain Embodiments of the Invention

The Figures in this disclosure use the following numbers and terms; wheel link (1); rate link (2); shock link (3); wheel link fixed pivot (4); shock link fixed pivot (5); wheel link floating pivot (6); shock link floating pivot (7); first shock pivot (8); second shock pivot (9); wheel (or hub) rotation axis (10); frame (11); frame support (12); shock absorber (13); bottom bracket shell (14); downtube (15); front wheel (16); rear wheel (17) axle path (18); vertical wheel compression distance (19); shock absorber length (20); leverage ratio curve (35); beginning (36); middle (37); end (38).

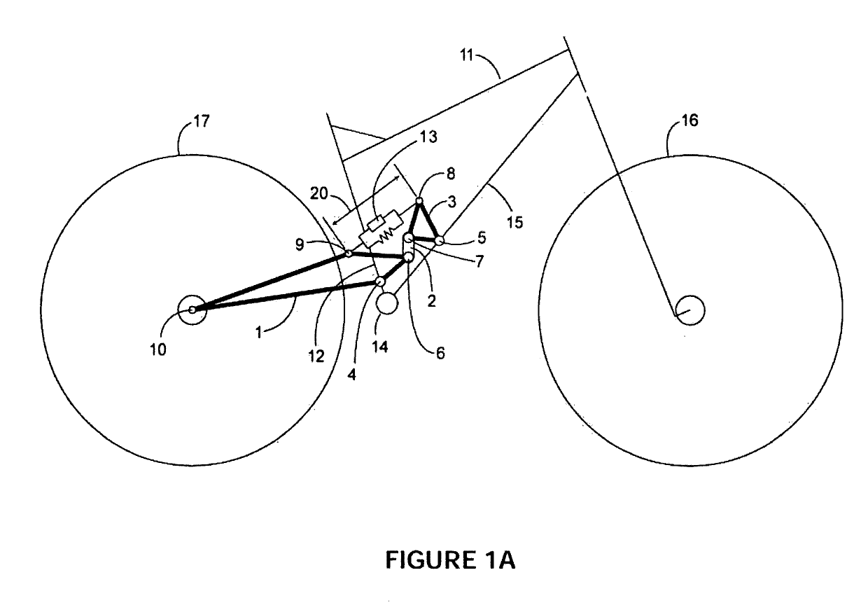

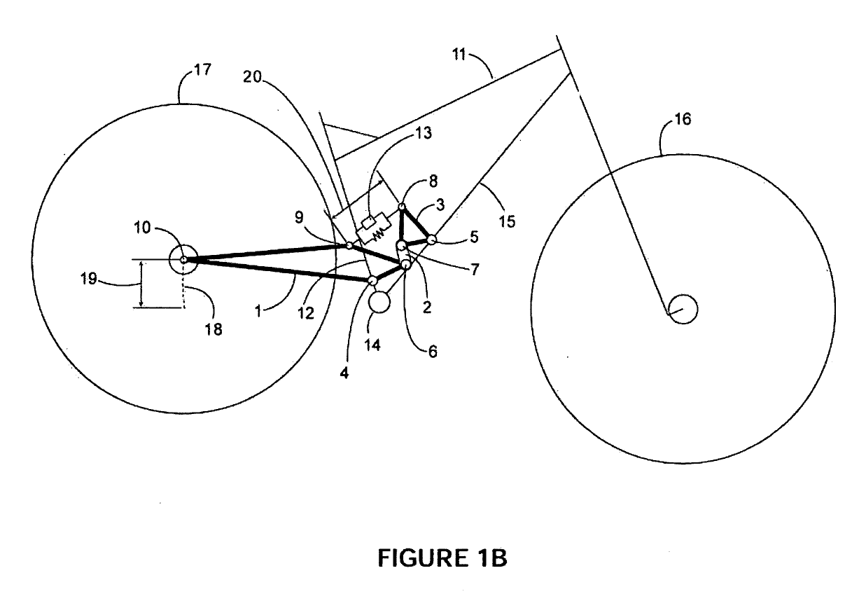

FIG. 1A presents a design for a suspension according to certain embodiments of the current invention via a two-dimensional right side view with the suspension in an uncompressed state. Shown in FIG. 1A are the following: wheel link (1); rate link (2); shock link (3); wheel link fixed pivot (4); shock link fixed pivot (5); wheel link floating pivot (6); shock link floating pivot (7); first shock pivot (8); second shock pivot (9); wheel (or hub) rotation axis (10); frame (11); frame support (12); shock absorber (13); bottom bracket shell (14); downtube (15); front wheel (16); rear wheel (17); shock absorber length (20). A frame 11 provides the structure for the bicycle. The frame 11 is shown as a series of lines that depict a structural layout for a bicycle. The frame 11 provides a support or mounting location for powertrain components such as; sprockets, cranks, bottom brackets, gears, transmissions, suspension parts such as forks, rear suspension and front suspension; operator interfaces such as handlebars and seats; and accessories such as water bottles and batteries for lights. Two wheels, a front wheel 16 and a rear wheel 17 are shown in FIG. 1. A wheel link 1 is mounted to the frame 11 via a wheel link fixed pivot 4. The wheel link fixed pivot 4 is a mounting location which allows for wheel link 1 articulation in at least one degree of freedom. The wheel link fixed pivot 4 and all other pivoting locations are shown as small circles in FIG. 1. The wheel link 1 holds a wheel link fixed pivot 4 and a wheel link floating pivot 6 at a fixed distance apart from each other. The wheel link 1 allows the rear wheel 17 to articulate around the wheel link fixed pivot 4 at a constant or close to constant radius. The rear wheel 17 has a wheel rotation axis 10 which is connected to the wheel link 1. The wheel floating link pivot 6 pivotally connects the wheel link 1 to a rate link 2. The rate link 2 is pivotally connected to the shock link 3 via the shock link floating pivot 7. The rate link 2 transmits force from a wheel link 1 to a shock link 3 via the wheel link floating pivot 6 and shock link floating pivot 7. The shock link 3 is pivotally attached to the frame 11 via the shock link fixed pivot 5. The shock link 3 is attached to a shock absorber 13 via a first shock pivot 8. The shock absorber 13 is mounted to the wheel link 1 via a second shock pivot 9. A shock absorber can comprise a spring and a damper. The shock absorber 13 has a shock absorber length 20, which is measured as the aligned distance between a first shock pivot 8 and second shock pivot 9. The movement of the first shock pivot 8 and second shock pivot 9 causes the shock absorber length 20 to change as the suspension is moved to a state of full compression. The incremental ratio of vertical wheel compression distance to shock absorber length 20 change is called leverage ratio. Leverage ratio multiplied by shock absorber 13 spring rate is called wheel rate, where wheel rate and leverage ratio can be important information used by an engineer to design specific performance parameters into the suspension. The frame 11 can comprise structural elements which can include a frame support 12, bottom bracket shell 14, and downtube 15. The downtube 15 is typically the strongest structural member on the frame 11, and the shock link fixed pivot 5 is located in close proximity to the downtube 15 to take advantage of its strength. The bottom bracket shell 14 is part of a frame structure 11, and is structurally attached to a downtube 15 and frame support 12. The bottom bracket 14 can be either directly or indirectly attached to the downtube 15 or frame support 12. The frame support 12 can consist of a single sided strut that passes next to only one side of a shock absorber 13, or a double sided strut that passes next to both sides of a shock absorber 13. The downtube 15 can consist of a single sided strut that passes substantially below only one side of a shock absorber 13, or a double sided strut that passes substantially next to both sides of a shock absorber 13.

FIG. 1B presents a design for a suspension according to certain embodiments of the current invention via a two-dimensional right side view with the suspension in a compressed state. Shown in FIG. 1B are the following: wheel link (1); rate link (2); shock link (3); wheel link fixed pivot (4); shock link fixed pivot (5); wheel link floating pivot (6); shock link floating pivot (7); first shock pivot (8); second shock pivot (9); wheel (or hub) rotation axis (10); frame (11); frame support (12); shock absorber (13); bottom bracket shell (14); downtube (15); front wheel (16); rear wheel (17); axle path (18); vertical wheel compression distance (19); shock absorber length (20). A frame 11 provides the structure for the bicycle. The frame 11 is shown as a series of lines that depict a structural layout for a bicycle. The frame 11 provides a support or mounting location for powertrain components such as; sprockets, cranks, bottom brackets, gears, transmissions, suspension parts such as forks, rear suspension and front suspension; operator interfaces such as handlebars and seats; and accessories such as water bottles and batteries for lights. Two wheels, a front wheel 16 and a rear wheel 17 are shown in FIG. 1. A wheel link 1 is mounted to the frame 11 via a wheel link fixed pivot 4. The wheel link fixed pivot 4 is a mounting location which allows for wheel link 1 articulation in at least one degree of freedom. The wheel link fixed pivot 4 and all other pivoting locations are shown as small circles in FIG. 1. The wheel link 1 holds a wheel link fixed pivot 4 and a wheel link floating pivot 6 at a fixed distance apart from each other. The wheel link 1 allows the rear wheel 17 to articulate around the wheel link fixed pivot 4 at a constant or close to constant radius. This radius is shown as the axle path 18. The rear wheel 17 has a wheel rotation axis 10 which is connected to the wheel link 1. The wheel floating link pivot 6 pivotally connects the wheel link 1 to a rate link 2. The rate link 2 is pivotally connected to the shock link 3 via the shock link floating pivot 7. The rate link 2 transmits force from a wheel link 1 to a shock link 3 via the wheel link floating pivot 6 and shock link floating pivot 7. The shock link 3 is pivotally attached to the frame 11 via the shock link fixed pivot 5. The shock link 3 is attached to a shock absorber 13 via a first shock pivot 8. The shock absorber 13 is mounted to the wheel link 1 via a second shock pivot 9. As the rear wheel 17 moves upwards away from a bump, the wheel link 1 rotates in a clockwise direction around the wheel link fixed pivot 4. The wheel rotation axis moves in an upwards direction, while the wheel link floating pivot 6 moves in a downward direction as it rotates around the wheel link fixed pivot 4. The rate link 2 is pivotally attached to the wheel ink 1 via the wheel link floating pivot 6, so as the wheel link 1 rotates in a clockwise direction, the rate link 2 moves downward. The shock link 3 is pivotally attached to the rate link 2 via the shock link floating pivot 7, so as the rate link 2 moves downward, the shock link 3 rotates in a counter clockwise direction about the shock link fixed pivot 5. The shock absorber 13 is pivotally attached to the shock link 3 via a first shock pivot 8. As the shock link 3 rotates in a counter clockwise direction about the shock link floating pivot 5, the first shock pivot 8 moves in a clockwise direction around the shock link floating pivot 5. The second shock pivot 9 is pivotally attached to the wheel link 1. As the wheel link 1 rotates in a clockwise direction about the wheel link floating pivot 4, the second shock pivot 9 moves in a direction that forces the shock absorber length 20 to change as the vertical wheel compression distance 19 changes. A shock absorber can comprise a spring and a damper. The shock absorber 13 has a shock absorber length 20, which is measured as the aligned distance between a first shock pivot 8 and second shock pivot 9. The movement of the first shock pivot 8 and second shock pivot 9 causes the shock absorber length 20 to change as the suspension is moved to a state of full compression. The incremental ratio of vertical wheel compression distance 19 to shock absorber length 20 change is called leverage ratio. Leverage ratio multiplied by shock absorber 13 spring rate is called wheel rate, where wheel rate and leverage ratio can be important information used by an engineer to design specific performance parameters into the suspension. The frame 11 can comprise structural elements which can include a frame support 12, bottom bracket shell 14, and downtube 15. The downtube 15 is typically the strongest structural member on the frame 11, and the shock link fixed pivot 5 is located in close proximity to the downtube 15 to take advantage of its strength. The bottom bracket shell 14 is part of a frame structure 11, and is structurally attached to a downtube 15 and frame support 12. The bottom bracket 14 can be either directly or indirectly attached to the downtube 15 or frame support 12. The frame support 12 can consist of a single sided strut that passes next to only one side of a shock absorber 13, or a double sided strut that passes next to both sides of a shock absorber 13. The downtube 15 can consist of a single sided strut that passes substantially below only one side of a shock absorber 13, or a double sided strut that passes substantially next to both sides of a shock absorber 13.

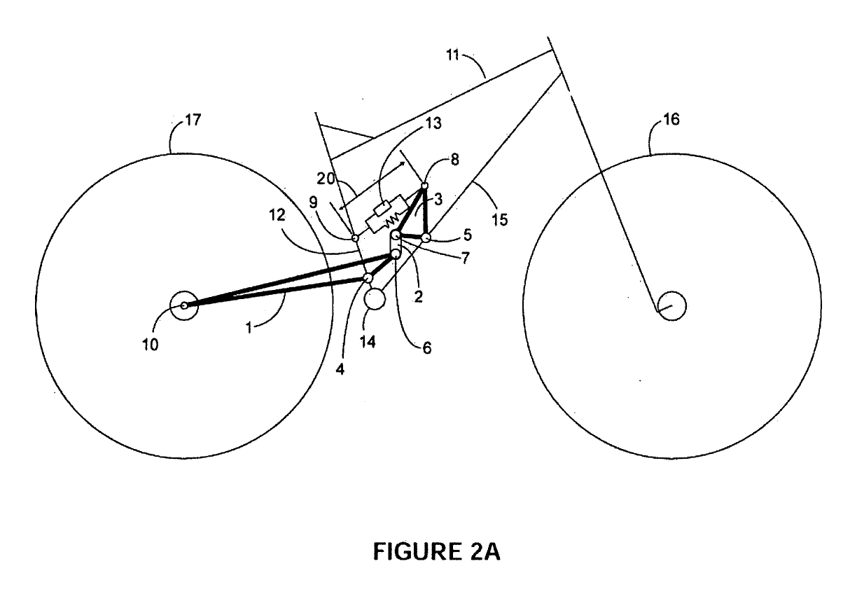

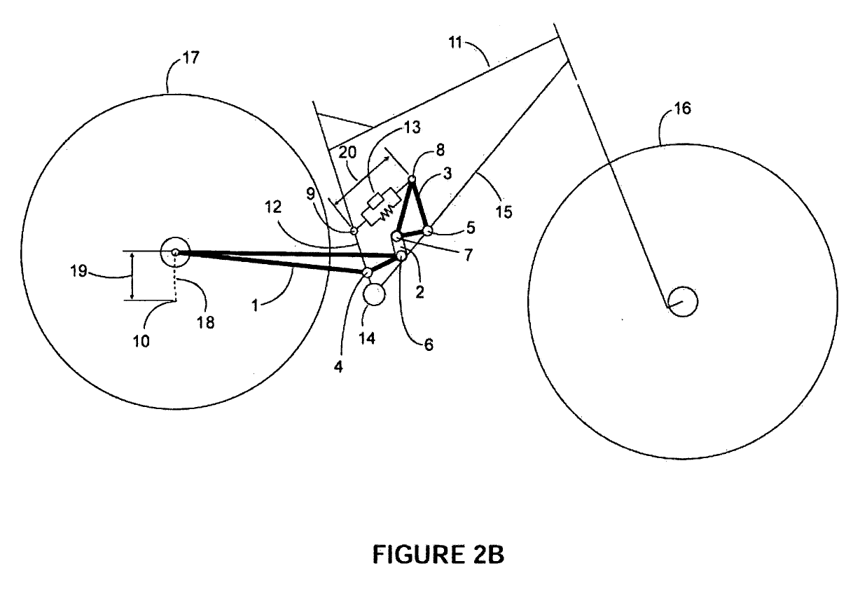

FIG. 2A presents a design for a suspension according to certain embodiments of the current invention via a two-dimensional right side view with the suspension in an uncompressed state. Shown in FIG. 2A are the following: wheel link (1); rate link (2); shock link (3); wheel link fixed pivot (4); shock link fixed pivot (5); wheel link floating pivot (6); shock link floating pivot (7); first shock pivot (8); second shock pivot (9); wheel (or hub) rotation axis (10); frame (11); frame support (12); shock absorber (13); bottom bracket shell (14); downtube (15); front wheel (16); rear wheel (17); shock absorber length (20). A frame 11 provides the structure for the bicycle. The frame 11 is shown as a series of lines that depict a structural layout for a bicycle. The frame 11 provides a support or mounting location for powertrain components such as; sprockets, cranks, bottom brackets, gears, transmissions, suspension parts such as forks, rear suspension and front suspension; operator interfaces such as handlebars and seats; and accessories such as water bottles and batteries for lights. Two wheels, a front wheel 16 and a rear wheel 17 are shown in FIG. 1. A wheel link 1 is mounted to the frame 11 via a wheel link fixed pivot 4. The wheel link fixed pivot 4 is a mounting location which allows for wheel link 1 articulation in at least one degree of freedom. The wheel link fixed pivot 4 and all other pivoting locations are shown as small circles in FIG. 1. The wheel link 1 holds a wheel link fixed pivot 4 and a wheel link floating pivot 6 at a fixed distance apart from each other. The wheel link 1 allows the rear wheel 17 to articulate around the wheel link fixed pivot 4 at a constant or close to constant radius. The rear wheel 17 has a wheel rotation axis 10 which is connected to the wheel link 1. The wheel floating link pivot 6 pivotally connects the wheel link 1 to a rate link 2. The rate link 2 is pivotally connected to the shock link 3 via the shock link floating pivot 7. The rate link 2 transmits force from a wheel link 1 to a shock link 3 via the wheel link floating pivot 6 and shock link floating pivot 7. The shock link 3 is pivotally attached to the frame 11 via the shock link fixed pivot 5. The shock link 3 is attached to a shock absorber 13 via a first shock pivot 8. The shock absorber 13 is mounted to the frame 11 via a second shock pivot 9. A shock absorber can comprise a spring and a damper. The shock absorber 13 has a shock absorber length 20, which is measured as the aligned distance between a first shock pivot 8 and second shock pivot 9. The movement of the first shock pivot 8 and fixed location of the second shock pivot 9 causes the shock absorber length 20 to change as the suspension is moved to a state of full compression. The incremental ratio of vertical wheel compression distance to shock absorber length 20 change is called leverage ratio. Leverage ratio multiplied by shock absorber 13 spring rate is called wheel rate, where wheel rate and leverage ratio can be important information used by an engineer to design specific performance parameters into the suspension. The frame 11 can comprise structural elements which can include a frame support 12, bottom bracket shell 14, and downtube 15. The downtube 15 is typically the strongest structural member on the frame 11, and the shock link fixed pivot 5 is located in close proximity to the downtube 15 to take advantage of its strength. The bottom bracket shell 14 is part of a frame structure 11, and is structurally attached to a downtube 15 and frame support 12. The bottom bracket 14 can be either directly or indirectly attached to the downtube 15 or frame support 12. The frame support 12 can consist of a single sided strut that passes next to only one side of a shock absorber 13, or a double sided strut that passes next to both sides of a shock absorber 13. The downtube 15 can consist of a single sided strut that passes substantially below only one side of a shock absorber 13, or a double sided strut that passes substantially next to both sides of a shock absorber 13.

FIG. 2B presents a design for a suspension according to certain embodiments of the current invention via a two-dimensional right side view with the suspension in a compressed state. Shown in FIG. 2B are the following: wheel link (1); rate link (2); shock link (3); wheel link fixed pivot (4); shock link fixed pivot (5); wheel link floating pivot (6); shock link floating pivot (7); first shock pivot (8); second shock pivot (9); wheel (or hub) rotation axis (10); frame (11); frame support (12); shock absorber (13); bottom bracket shell (14); downtube (15); front wheel (16); rear wheel (17); axle path (18); vertical wheel compression distance (19); shock absorber length (20). A frame 11 provides the structure for the bicycle. The frame 11 is shown as a series of lines that depict a structural layout for a bicycle. The frame 11 provides a support or mounting location for powertrain components such as; sprockets, cranks, bottom brackets, gears, transmissions, suspension parts such as forks, rear suspension and front suspension; operator interfaces such as handlebars and seats; and accessories such as water bottles and batteries for lights. Two wheels, a front wheel 16 and a rear wheel 17 are shown in FIG. 1. A wheel link 1 is mounted to the frame 11 via a wheel link fixed pivot 4. The wheel link fixed pivot 4 is a mounting location which allows for wheel link 1 articulation in at least one degree of freedom. The wheel link fixed pivot 4 and all other pivoting locations are shown as small circles in FIG. 1. The wheel link 1 holds a wheel link fixed pivot 4 and a wheel link floating pivot 6 at a fixed distance apart from each other. The wheel link 1 allows the rear wheel 17 to articulate around the wheel link fixed pivot 4 at a constant or close to constant radius. This radius is shown as the axle path 18. The rear wheel 17 has a wheel rotation axis 10 which is connected to the wheel link 1. The wheel floating link pivot 6 pivotally connects the wheel link 1 to a rate link 2. The rate link 2 is pivotally connected to the shock link 3 via the shock link floating pivot 7. The rate link 2 transmits force from a wheel link 1 to a shock link 3 via the wheel link floating pivot 6 and shock link floating pivot 7. The shock link 3 is pivotally attached to the frame 11 via the shock link fixed pivot 5. The shock link 3 is attached to a shock absorber 13 via a first shock pivot 8. The shock absorber 13 is mounted to the frame 11 via a second shock pivot 9. As the rear wheel 17 moves upwards away from a bump, the wheel link 1 rotates in a clockwise direction around the wheel link fixed pivot 4. The wheel rotation axis moves in an upwards direction, while the wheel link floating pivot 6 moves in a downward direction as it rotates around the wheel link fixed pivot 4. The rate link 2 is pivotally attached to the wheel link 1 via the wheel link floating pivot 6, so as the wheel link 1 rotates in a clockwise direction, the rate link 2 moves downward. The shock link 3 is pivotally attached to the rate link 2 via the shock link floating pivot 7, so as the rate link 2 moves downward, the shock link 3 rotates in a counter clockwise direction about the shock link fixed pivot 5. The shock absorber 13 is pivotally attached to the shock link 3 via a first shock pivot 8. As the shock link 3 rotates in a counter clockwise direction about the shock link floating pivot 5, the first shock pivot 8 moves in a clockwise direction around the shock link floating pivot 5. The second shock pivot 9 is pivotally attached to the frame 11. As the wheel link 1 rotates in a clockwise direction about the wheel link floating pivot 4, the collective movement and rotation of the rate link 2, and shock link 3 moves the first shock pivot 8 in a direction that forces the shock absorber length 20 to change as the vertical wheel compression distance 19 changes. A shock absorber can comprise a spring and a damper. The shock absorber 13 has a shock absorber length 20, which is measured as the aligned distance between a first shock pivot 8 and second shock pivot 9. The movement of the first shock pivot 8 and second shock pivot 9 causes the shock absorber length 20 to change as the suspension is moved to a state of full compression. The incremental ratio of vertical wheel compression distance 19 to shock absorber length 20 change is called leverage ratio, leverage rate, motion ratio, or motion rate. Leverage ratio multiplied by shock absorber 13 spring rate is called wheel rate, where wheel rate and leverage ratio can be important information used by an engineer to design specific performance parameters into the suspension. The frame 11 can comprise structural elements which can include a frame support 12, bottom bracket shell 14, and downtube 15. The downtube 15 is typically the strongest structural member on the frame 11, and the shock link fixed pivot 5 is located in close proximity to the downtube 15 to take advantage of its strength. The bottom bracket shell 14 is part of a frame structure 11, and is structurally attached to a downtube 15 and frame support 12. The bottom bracket 14 can be either directly or indirectly attached to the downtube 15 or frame support 12. The frame support 12 can consist of a single sided strut that passes next to only one side of a shock absorber 13, or a double sided strut that passes next to both sides of a shock absorber 13. The downtube 15 can consist of a single sided strut that passes substantially below only one side of a shock absorber 13, or a double sided strut that passes substantially next to both sides of a shock absorber 13.

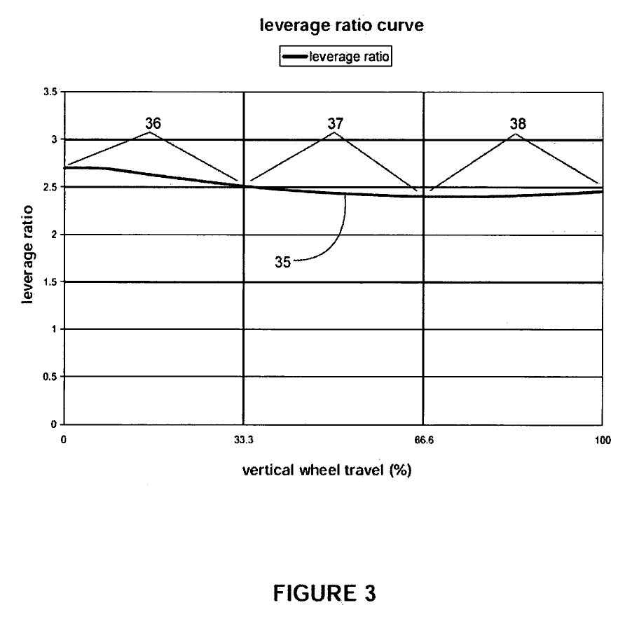

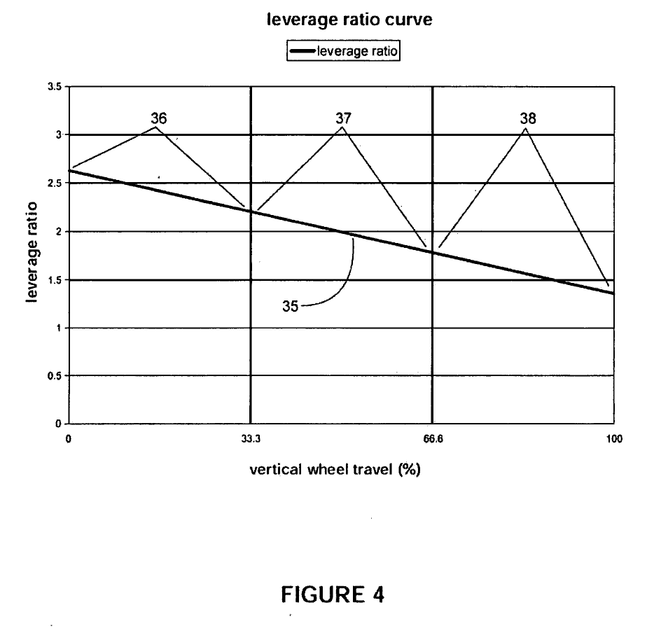

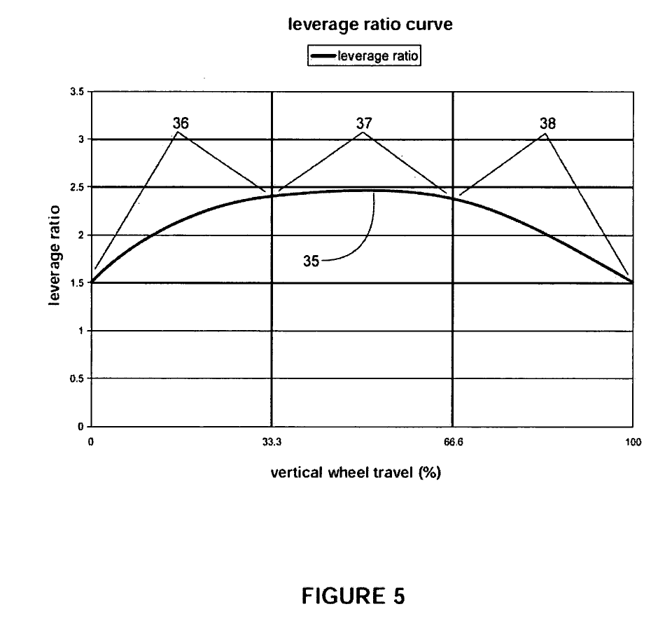

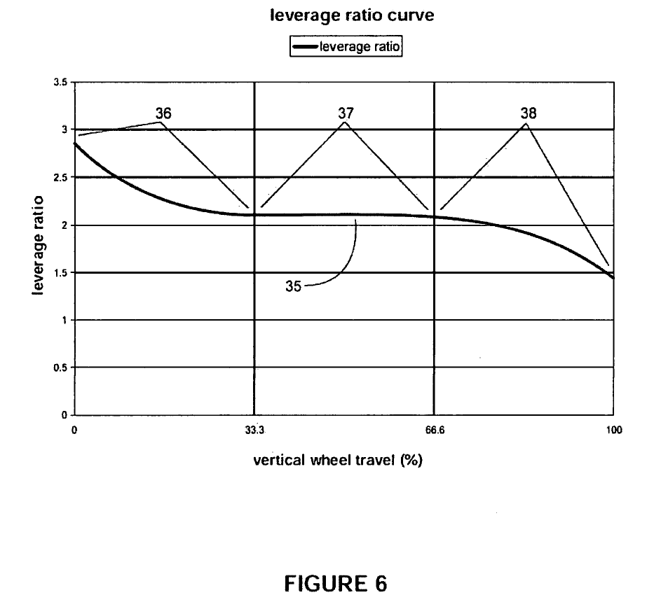

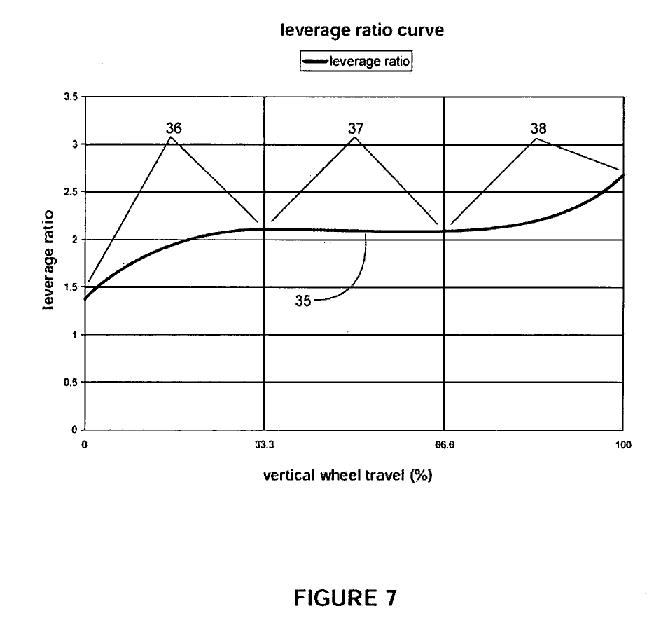

FIGS. 3 to 7 illustrate leverage ratio curves according to specific embodiments of the current invention. A leverage ratio curve 35 is a graphed quantifiable representation of leverage ratio versus wheel compression distance or percentage of full compression. Wheel compression distance or vertical wheel travel is measured perpendicular to gravity with the initial 0 percent measurement taken at full suspension extension with the bicycle unladen and on even ground. As a suspension of the invention is compressed from a point of full extension to a point of full compression at a constant rate, measurements of shock absorber length are taken as the shortest distance between a first shock pivot and a second shock pivot at equal increments of shock absorber compression. When graphed as a curve on a Cartesian graph, leverage ratio is shown on the Y axis escalating from the x axis in a positive direction, and vertical wheel travel is shown on the X axis escalating from the Y axis in a positive direction. Leverage ratios of the current invention are designed to achieve a desired force output at a wheel. In certain embodiments a leverage ratio curve 35 can be broken down into three equal parts in relation to wheel compression distance or vertical wheel travel, a beginning ⅓, 36, a middle ⅓, 37, and an end ⅓, 38.

### 5.2 Wheel Links of Suspension Systems of the Invention

A suspension system of the current invention, in certain embodiments, comprises a wheel link, or two, three, four, five or more wheel links. A wheel link, in certain embodiments, is connected to a frame, a shock absorber, a first shock pivot, a second shock pivot, a wheel link floating pivot and/or a wheel link fixed pivot. In certain embodiments, a wheel link is located substantially behind (in other words, closer to the rear wheel rotation axis than) a rate link, a shock link floating pivot, a shock link, a first shock pivot, a shock absorber, a second shock pivot, or any one or more of these components of a suspension system according to the invention when the suspension is uncompressed and the bicycle is on even ground when even ground is perpendicular to gravity. In certain embodiments, a wheel link supports a wheel rotation axis and a wheel link floating pivot so that the wheel rotation axis and wheel link floating pivot rotate about a wheel link fixed pivot as the suspension is compressed. When the suspension is compressed and the bicycle is viewed from the right side, the wheel link rotates in a clockwise direction, and in certain embodiments, the wheel rotation axis moves in an upward or generally upward direction, while the wheel link floating pivot moves in a downward or generally downward direction. A wheel link can have a length that can be measured as the shortest aligned distance between the wheel link fixed pivot to the rear wheel rotation axis. In certain other embodiments, a suspension system of the invention comprises a wheel link that is the same length or about the same length as a rate link of that suspension system. In certain other embodiments, a suspension system of the invention comprises a wheel link that is 50 percent or about 50 percent longer or shorter than a rate link of that suspension system, or 100 percent or about 100 percent longer or shorter, or 500 percent or about 500 percent longer or shorter, or 1000 percent or about 1000 percent longer or shorter, or 5 to 500 percent longer or shorter, or 5 to 1000 percent longer or shorter, or 5 to 2000 percent longer or shorter, or 5 to 5000 percent longer or shorter, or 5 to 10000 percent longer or shorter. In certain other embodiments, a wheel link of the invention is 2 to 50 centimeters (cm) in length, or 30 to 45 cm, or 35 to 40 cm.

### 5.3 Rate Links of Suspension Systems of the Invention

A suspension system of the current invention, in certain embodiments, comprises a rate link, or two, three, four, five or more rate links. A rate link, in certain embodiments, is connected to a wheel link floating pivot, a shock link floating pivot, and/or a first shock pivot, and/or a second shock pivot. In certain embodiments, a rate link is located above (in other words, further from the ground than) a wheel link of a suspension system according to the invention when the suspension is uncompressed and the bicycle is on even ground when even ground is perpendicular to gravity. In certain embodiments, a rate link is located below (in other words, closer to the ground than) a shock link floating pivot, a first shock pivot, a shock absorber, and/or a second shock pivot, or any one or more of these components of a suspension system according to the invention when the suspension is uncompressed and the bicycle is on even ground when even ground is perpendicular to gravity. In certain embodiments, a rate link is located below (in other words, closer to the ground than) a wheel link of a suspension system according to the invention when the suspension is uncompressed and the bicycle is on even ground when even ground is perpendicular to gravity. In certain embodiments, a rate link is located above (in other words, further from the ground than) a shock link floating pivot, a first shock pivot, a shock absorber, and/or a second shock pivot, or any one or more of these components of a suspension system according to the invention when the suspension is uncompressed and the bicycle is on even ground when even ground is perpendicular to gravity. A rate link can have a length that can be measured as the shortest aligned distance between the wheel link floating pivot to the shock link floating pivot. In certain other embodiments, a suspension system of the invention comprises a rate link that is 50 percent or about 50 percent longer or shorter than a wheel link of that suspension system, or 100 percent or about 100 percent longer or shorter, or 500 percent or about 500 percent longer or shorter, or 1000 percent or about 1000 percent longer or shorter, or 5 to 500 percent longer or shorter, or 5 to 1000 percent longer or shorter, or 5 to 2000 percent longer or shorter, or 5 to 5000 percent longer or shorter, or 5 to 10000 percent longer or shorter. In certain other embodiments, a rate link of the invention is 0.1 to 50 centimeters (cm) in length, or 0.1 to 10 cm, or 0.1 to 5 cm.

In certain other embodiments, a rate link and a wheel link of a suspension system of the invention are arranged relative to each other in a non-parallel manner when observed from the side of the bicycle comprising the suspension system. In certain embodiments, a rate link and a wheel link are arranged relative to each other at an angle of 0 to 150 degrees, or 0 to 100 degrees, or 0 to 80 degrees, or 10 to 60 degrees, or 15 to 40 degrees, or 20 to 30 degrees, when observed from the side of the bicycle, while the suspension of said bicycle is uncompressed and the bicycle is on even ground when even ground is perpendicular to gravity. In certain other embodiments, a rate link passes on a side of a frame member or on two sides of a frame member, frame support, or downtube. As the rear wheel moves upwards away from a bump, in certain embodiments the wheel link rotates in a clockwise direction around the wheel link fixed pivot. In certain embodiments, the wheel rotation axis moves in an upwards direction, while the wheel link floating pivot moves in a downward direction as it rotates around the wheel link fixed pivot. In certain embodiments, the rate link is pivotally attached to the wheel link via the wheel link floating pivot, so as the wheel link rotates in a clockwise direction, the rate link moves downward. In certain embodiments, the shock link is pivotally attached to the rate link via the shock link floating pivot, so as the rate link moves downward, the shock link rotates in a counter clockwise direction about the shock link fixed pivot. In certain embodiments, the rate link is loaded in tension so that forces in the rate link pull the wheel link floating pivot and shock link floating pivot away from each other as the shock is compressed and resists wheel link rotation. In certain embodiments, the rate link is loaded in compression so that forces in the rate link push the wheel link floating pivot and shock link floating pivot towards each other as the shock is compressed and resists wheel link rotation. In certain embodiments, the shock absorber is pivotally attached to the shock link via a first shock pivot. In certain embodiments, as the shock link rotates in a counter clockwise direction about the shock link floating pivot, the first shock pivot moves in a counter clockwise direction around the shock link floating pivot. In certain embodiments, the second shock pivot is pivotally attached to the frame. In certain embodiments, as the wheel link rotates in a clockwise direction about the wheel link floating pivot, the collective movement and rotation of the rate link, and shock link moves the first shock pivot in a direction that forces the shock absorber length to change as the vertical wheel compression distance changes. In certain embodiments, a rate link can rotate on pivots. Pivots can comprise bearings, bushings, pivot shafts, thrust washers, and other mechanical elements intended to allow a rate link and pivotally attached members to transfer force between one another while allowing movement in at least one degree of freedom. Pivot bearings or bushings in certain embodiments can rotate around pivot shafts. In certain embodiments a rate link can be designed so that a wheel link floating pivot and shock link floating pivot are positioned next to each other so that pivot shafts are spaced next to each other so that the outer circumference of the pivot shafts do not overlap. In certain embodiments a rate link can be designed so that a wheel link floating pivot and shock link floating pivot are positioned next to each other so that circumference of the pivot shafts are spaced so that the outer circumferences of the pivot shafts are overlapping in relation to each other. In certain embodiments a rate link can be designed so that a wheel link floating pivot and shock link floating pivot are positioned so that one of the outer circumferences of the pivot shafts is nested inside another circumference of a pivot shaft in an eccentric manner. In certain embodiments, a rate link can be located above a wheel link fixed pivot. In certain embodiments, a rate link can be located in front of a wheel link fixed pivot. In certain embodiments, a rate link can be located below a wheel link fixed pivot. In certain embodiments, a rate link can be located behind a wheel link fixed pivot. In certain embodiments, a rate link can be located substantially above a wheel link fixed pivot. In certain embodiments, a rate link can be located substantially in front of a wheel link fixed pivot. In certain embodiments, a rate link can be located substantially below a wheel link fixed pivot. In certain embodiments, a rate link can be located substantially behind a wheel link fixed pivot. In certain embodiments, a rate link can be located substantially above a wheel link fixed pivot. In certain embodiments, a rate link can be located substantially in front of a wheel link fixed pivot. In certain embodiments, a rate link can be located substantially above a wheel link floating pivot. In certain embodiments, a rate link can be located substantially below a wheel link floating pivot. In certain embodiments, a rate link can be located substantially behind a wheel link floating pivot. In certain embodiments, a rate link can be located substantially in front of a wheel link floating pivot.

### 5.4 Shock Links of Suspension Systems of the Invention

A suspension system of the current invention, in certain embodiments, comprises a shock link, or two, three, four, five or more shock links. A shock link of a suspension system of the invention, in certain embodiments, is connected to a rate link. In certain other embodiments, a shock link is connected to a shock link floating pivot, a rate link, a shock link fixed pivot, a shock absorber, first shock pivot, and/or a second shock pivot. In certain other embodiments, a shock link passes on a side of a frame member or on two sides of a frame member.

In certain embodiments, the shock link is pivotally attached to the rate link via the shock link floating pivot, so as the rate link moves downward, the shock link rotates in a counter clockwise direction about the shock link fixed pivot. In certain embodiments, the shock absorber is pivotally attached to the shock link via a first shock pivot. In certain embodiments, as the shock link rotates in a counter clockwise direction about the shock link floating pivot, the first shock pivot moves in a counter clockwise direction around the shock link floating pivot. In certain embodiments, the second shock pivot is pivotally attached to the frame. In certain embodiments, as the wheel link rotates in a clockwise direction about the wheel link floating pivot, the collective movement and rotation of the rate link, and shock link moves the first shock pivot in a direction that forces the shock absorber length to change as the vertical wheel compression distance changes.

In certain embodiments, as the wheel link rotates in a clockwise direction about the wheel link floating pivot, the rate link moves downward, and the shock link rotates in a counter clockwise direction so that the first shock pivot moves in a direction that forces the shock absorber length to change as the vertical wheel compression distance changes.

In certain embodiments, as the wheel link rotates in a clockwise direction about the wheel link floating pivot, the shock link rotates in a counter clockwise direction so that the first shock pivot moves in a direction that forces the shock absorber length to change as the vertical wheel compression distance changes.

In certain embodiments, as the wheel link rotates in a clockwise direction about the wheel link floating pivot, the shock link rotates in a counter clockwise direction.

In certain embodiments, the wheel link and shock links rotate in opposite directions as the shock absorber length and vertical wheel compression distance change.

In certain embodiments, a shock link can rotate on pivots. Pivots can comprise bearings, bushings, pivot shafts, thrust washers, and other mechanical elements intended to allow a shock link and pivotally attached members to transfer force between one another while allowing movement in at least one degree of freedom. Pivot bearings or bushings in certain embodiments can rotate around pivot shafts.

In certain embodiments, a shock link is located in front of a wheel link, a wheel link floating pivot, a wheel link fixed pivot, a first shock pivot, a shock absorber, a second shock pivot, a shock link fixed pivot, or any one or more of these components, of a suspension system according to the invention when the suspension is uncompressed and the bicycle is on even ground when even ground is perpendicular to gravity.

In certain embodiments, a shock link is located above a wheel link, a wheel link floating pivot, a wheel link fixed pivot, a first shock pivot, a shock absorber, a second shock pivot, a shock link fixed pivot, or any one or more of these components, of a suspension system according to the invention when the suspension is uncompressed and the bicycle is on even ground when even ground is perpendicular to gravity.

In certain embodiments, a shock link is located below a shock link floating pivot, a first shock pivot, a shock absorber, and/or a second shock pivot, or any one or more of these components, of a suspension system according to the invention when the suspension is uncompressed and the bicycle is on even ground when even ground is perpendicular to gravity.

A shock link can have a first length that can be measured as the shortest aligned distance between the shock link fixed pivot to the shock link floating pivot. A shock link can have a first length that can be measured as the shortest aligned distance between the shock link fixed pivot to the first shock pivot. In certain other embodiments, a suspension system of the invention comprises a shock link first length with a length that is 2 percent or about 2 percent of the length of a wheel link of that suspension system, or 5 percent or about 5 percent longer or shorter, or 10 percent or about 10 percent longer or shorter, or 20 percent or about 20 percent longer or shorter, or 30 percent or about 30 percent longer or shorter, or 2 to 20 percent longer or shorter, or 2 to 50 percent longer or shorter, or 2 to 100 percent longer or shorter, or 2 to 200 percent longer or shorter, or 2 to 500 percent longer or shorter.

In certain other embodiments, a shock link first length of the invention is 0.5 to 50 cm in length, or 0.5 to 25 cm, or 1 to 15 cm. In certain other embodiments, a suspension system of the invention comprises a shock link second length with a length that is 2 percent or about 2 percent of the length of a wheel link of that suspension system, or 5 percent or about 5 percent longer or shorter, or 10 percent or about 10 percent longer or shorter, or 20 percent or about 20 percent longer or shorter, or 30 percent or about 30 percent longer or shorter, or 2 to 20 percent longer or shorter, or 2 to 50 percent longer or shorter, or 2 to 100 percent longer or shorter, or 2 to 200 percent longer or shorter, or 2 to 500 percent longer or shorter. In certain other embodiments, a shock link second length of the invention is 0.5 to 50 cm in length, or 0.5 to 25 cm, or 1 to 15 cm. In certain embodiments, a shock link can be located above a wheel link fixed pivot. In certain embodiments, a shock link can be located in front of a wheel link fixed pivot. In certain embodiments, a shock link can be located below a wheel link fixed pivot. In certain embodiments, a shock link can be located behind a wheel link fixed pivot. In certain embodiments, a shock link can be located substantially above a wheel link fixed pivot. In certain embodiments, a shock link can be located substantially in front of a wheel link fixed pivot. In certain embodiments, a shock link can be located substantially below a wheel link fixed pivot. In certain embodiments, a shock link can be located substantially behind a wheel link fixed pivot.

### 5.5 Wheel Link Fixed Pivots of Suspension Systems of the Invention

A suspension system of the current invention, in certain embodiments, comprises a wheel link fixed pivot, or two, three, four, five or more wheel link fixed pivots In certain embodiments, a wheel link fixed pivot can be fixed in relation to one or more of a frame support, downtube, frame, bottom bracket, so that a wheel link can rotate in at least one degree of freedom about the wheel link fixed pivot so as to allow rotational movement of the wheel link in relation to the frame, therefore allowing the rear wheel to rotate around the wheel link fixed pivot, and to furthermore allow movement of a wheel rotation axis in relation to the frame. In certain embodiments, a wheel link fixed pivot can comprise bearings, bushings, ball bearings, angular contact bearings, pivots, pivot shaft, bolt, axle, a rotation axis, a wheel link fixed pivot rotation axis. A wheel link fixed pivot in certain embodiments allows a wheel link to rotate around a wheel link pivot axis, where said wheel link pivot axis is coincident with a wheel link fixed pivot. In certain embodiments, a wheel link fixed pivot is located below a shock link, rate link, a wheel link floating pivot, a wheel link fixed pivot, a first shock pivot, a shock absorber, a second shock pivot, a shock link fixed pivot, bottom bracket shell, frame support, downtube, or any one or more of these components, of a suspension system according to the invention when the suspension is uncompressed and the bicycle is on even ground when even ground is perpendicular to gravity. In certain embodiments, a wheel link fixed pivot is located above a shock link, rate link, a wheel link floating pivot, a wheel link fixed pivot, a first shock pivot, a shock absorber, a second shock pivot, a shock link fixed pivot, bottom bracket shell, frame support, downtube, or any one or more of these components, of a suspension system according to the invention when the suspension is uncompressed and the bicycle is on even ground when even ground is perpendicular to gravity. In certain embodiments, a wheel link fixed pivot is located in front of a shock link, rate link, a wheel link floating pivot, a wheel link fixed pivot, a first shock pivot, a shock absorber, a second shock pivot, a shock link fixed pivot, bottom bracket shell, frame support, downtube, or any one or more of these components, of a suspension system according to the invention when the suspension is uncompressed and the bicycle is on even ground when even ground is perpendicular to gravity. In certain embodiments, a wheel link fixed pivot is located behind a shock link, rate link, a wheel link floating pivot, a wheel link fixed pivot, a first shock pivot, a shock absorber, a second shock pivot, a shock link fixed pivot, bottom bracket shell, frame support, downtube, or any one or more of these components, of a suspension system according to the invention when the suspension is uncompressed and the bicycle is on even ground when even ground is perpendicular to gravity. In certain embodiments, a wheel link fixed pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a bottom bracket shell. In certain embodiments, a wheel link fixed pivot can be concentric to a bottom bracket shell.

### 5.6 Shock Link Fixed Pivots of Suspension Systems of the Invention

A suspension system of the current invention, in certain embodiments, comprises a shock link fixed pivot, or two, three, four, five or more shock link fixed pivots. In certain embodiments, a shock link fixed pivot can be fixed in relation to one or more of a frame support, downtube, frame, bottom bracket, so that a shock link can rotate in at least one degree of freedom about the shock link fixed pivot so as to allow rotational movement of the shock link in relation to the frame, therefore allowing the shock link floating pivot and first shock pivot to rotate about the shock link fixed pivot. In certain embodiments, as the first shock pivot rotates about the shock link fixed pivot, the shock absorber changes length. In certain embodiments, a shock link fixed pivot can comprise bearings, bushings, ball bearings, angular contact bearings, pivots, a pivot axis, pivot shaft, bolt, axle, a rotation axis, a shock link fixed pivot rotation axis. A shock link fixed pivot in certain embodiments allows a shock link to rotate around a shock link pivot axis, where said shock link pivot axis is coincident with a shock link fixed pivot. In certain embodiments, a shock link fixed pivot is located below a wheel link, rate link, a wheel link floating pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity. In certain embodiments, a shock link fixed pivot is located above a wheel link, rate link, a wheel link floating pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity. In certain embodiments, a shock link fixed pivot is located in front of a wheel link, rate link, a wheel link floating pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity. In certain embodiments, a shock link fixed pivot is located behind a wheel link, rate link, a wheel link floating pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

### 5.7 Wheel Link Floating Pivots of Suspension Systems of the Invention

A suspension system of the current invention, in certain embodiments, comprises a wheel link floating pivot, or two, three, four, five or more wheel link floating pivots. In certain embodiments, a wheel link floating pivot can comprise bearings, bushings, ball bearings, angular contact bearings, pivots, a pivot axis, pivot shaft, bolt, axle, a rotation axis, a wheel link floating pivot rotation axis.

A wheel link floating pivot in certain embodiments allows a rate link to rotate around a pivot axis, where said pivot axis is coincident with a wheel link floating pivot. A wheel link floating pivot, in certain embodiments pivotally connects a wheel link and a rate link.

In certain embodiments, a wheel link floating pivot is located below a wheel link, rate link, shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, wheel link floating pivot is located above a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel link floating pivot is located in front of a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel link floating pivot is located behind a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel link floating pivot can be 0 mm to 10 mm, 0 mm to 50 mm, 0 mm to 70 mm, 0 mm to 100 mm, 0 mm to 120 mm, 0 mm to 150 mm, 0 mm to 200 mm away from a wheel link fixed pivot. In certain embodiments, a wheel link floating pivot can be 20 mm to 30 mm, 20 mm to 50 mm, 20 mm to 70 mm, 20 mm to 100 mm, 20 mm to 120 mm, 20 mm to 150 mm, 20 mm to 200 mm away from a wheel link fixed pivot.

### 5.8 Shock Link Floating Pivots of Suspension Systems of the Invention

A suspension system of the current invention, in certain embodiments, comprises a wheel link floating pivot, or two, three, four, five or more shock link floating pivots. In certain embodiments, a shock link floating pivot can comprise bearings, bushings, ball bearings, angular contact bearings, pivots, a pivot axis, pivot shaft, bolt, axle, a rotation axis, a wheel link floating pivot rotation axis.

A shock link floating pivot in certain embodiments allows a rate link to rotate around a pivot axis, where said pivot axis is coincident with a shock link floating pivot. A shock link floating pivot, in certain embodiments pivotally connects a shock link and a rate link.

In certain embodiments, a shock link floating pivot is located below a wheel link, rate link, shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, shock link floating pivot is located above a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a shock link floating pivot is located in front of a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a shock link floating pivot is located behind a wheel link, rate link, a shock link fixed pivot, a wheel link fixed pivot, a first shock pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

### 5.9 First Shock Pivots of Suspension Systems of the Invention

A suspension system of the current invention, in certain embodiments, comprises a first shock pivot, or two, three, four, five or more first shock pivots. In certain embodiments, a first shock pivot of the invention can be connected to a shock link, a rate link, a wheel link, a frame, frame member, downtube, bottom bracket shell, shock link floating pivot, a rate link floating pivot, a wheel link floating pivot, a wheel link fixed pivot, and/or share mounting with an other pivot.

In certain embodiments, a first shock pivot is located below a wheel link, rate link, shock link fixed pivot, a wheel link fixed pivot, a shock link floating pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, first shock pivot is located above a wheel link, rate link, a shock link fixed pivot, a wheel link fixed pivot, a shock link floating pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a first shock pivot is located in front of a wheel link, rate link, a shock link fixed pivot, a wheel link fixed pivot, a shock link floating pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a first shock pivot is located behind a wheel link, rate link, a shock link fixed pivot, a wheel link fixed pivot, a shock link floating pivot, a shock absorber, a second shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a first shock pivot can be In certain embodiments, a wheel rotation axis can be between 5 mm above to 5 mm below, 10 mm above to 10 mm below, 20 mm above to 20 mm below, 30 mm above to 30 mm below, 50 mm above to 50 mm below, 100 mm above to 100 mm below, 150 mm above to 150 mm below, 400 mm above to 400 mm below, 600 mm above to 600 mm below, 50 mm above to 400 mm below a wheel link fixed pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a bottom bracket shell. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm behind a bottom bracket shell.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a wheel link fixed pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a wheel link fixed pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a wheel link fixed pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a wheel link fixed pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a shock link fixed pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a shock link fixed pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a shock link fixed pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a shock link fixed pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a second shock pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a second shock pivot.

In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a second shock pivot. In certain embodiments, a first shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a second shock pivot.

### 5.10 Second Shock Pivots of Suspension Systems of the Invention

A suspension system of the current invention, in certain embodiments, comprises a second shock pivot, or two, three, four, five or more second shock pivots. In certain embodiments, a second shock pivot of the invention can be connected to a shock link, a rate link, a wheel link, a frame, frame member, downtube, bottom bracket shell, shock link floating pivot, a rate link floating pivot, a wheel link floating pivot, a wheel link fixed pivot, and/or share mounting with an other pivot.

In certain embodiments, a second shock pivot is located below a wheel link, rate link, shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, second shock pivot is located above a wheel link, rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a second shock pivot is located in front of a wheel link, rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a second shock pivot is located behind a wheel link, rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a bottom bracket shell. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a bottom bracket shell.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a bottom bracket shell. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm behind a bottom bracket shell.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a wheel link fixed pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a wheel link fixed pivot.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a wheel link fixed pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a wheel link fixed pivot.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a shock link fixed pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a shock link fixed pivot.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a shock link fixed pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a shock link fixed pivot.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm above a first shock pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm below a first shock pivot.

In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in front of a first shock pivot. In certain embodiments, a second shock pivot can be 0 mm to 10 mm, 0 mm to 30 mm, 0 mm to 50 mm, 0 mm to 70 mm, 0 mm to 100 mm, 0 mm to 150 mm, 0 mm to 400 mm, 0 mm to 600 mm in behind of a first shock pivot.

### 5.11 Wheel Rotation Axis of Suspension Systems of the Invention

A suspension system of the current invention, in certain embodiments, comprises a wheel rotation axis, or two or more wheel rotation axes. In certain embodiments, a wheel rotation axis is the axis of which a wheel rotates around. In certain embodiments, a wheel rotation axis is the axis of which a rear wheel rotates around. In certain embodiments, a wheel rotation axis is fixed in relation to a wheel link. In certain embodiments, a wheel link rotates about a wheel link fixed pivot, which in turn allows a wheel rotation axis to rotate around said wheel link fixed pivot.

In certain embodiments, a wheel rotation axis is located below a rate link, shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, wheel rotation axis is located above a rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel rotation axis is located in front of a rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel rotation axis is located behind a rate link, a shock link fixed pivot, a wheel link fixed pivot, a shock link floating pivot, a shock absorber, a first shock pivot, bottom bracket shell, frame support, downtube, or any one or more of these components, of a suspension system according to the invention when the suspension is uncompressed and the bicycle is on even ground when even ground is perpendicular to gravity.

In certain embodiments, a wheel rotation axis is located within 20 cm of the wheel link fixed pivot, or within 30 cm, or within 75 cm, or within 100 cm, or when the wheel axis and pivot axis are from 20 to 100 cm away from each other, or from 30 to 75 cm, or from 30 to 75 cm.

In certain embodiments, a wheel rotation axis can be 0 mm to 5 mm, 0 mm to 10 mm, 0 mm to 20 mm, 0 mm to 30 mm, 50 mm 0 mm to 100 mm, 0 mm to 150 mm, 0 mm to 400 mm, 0 mm to 600 mm above a wheel link fixed pivot. In certain embodiments, a wheel rotation axis can be 0 mm to 5 mm, 0 mm to 10 mm, 0 mm to 20 mm, 0 mm to 30 mm, 50 mm 0 mm to 100 mm, 0 mm to 150 mm, 0 mm to 400 mm, 0 mm to 600 mm below a wheel link fixed pivot.

In certain embodiments, a wheel rotation axis can be between 5 mm above to 5 mm below, 10 mm above to 10 mm below, 20 mm above to 20 mm below, 30 mm above to 30 mm below, 50 mm above to 50 mm below, 100 mm above to 100 mm below, 150 mm above to 150 mm below, 400 mm above to 400 mm below, 600 mm above to 600 mm below, 50 mm above to 400 mm below a wheel link fixed pivot.

### 5.12 Frames, Frame Supports, Bottom Bracket Shells, and Downtubes of Suspension Systems of the Invention

A frame in certain embodiments a frame can comprise structural elements which can include a frame support, bottom bracket shell, downtube, toptube, seat tube, upright, forged upright, seat tube support, support, head tube, strut. A strut in certain embodiments can be a generic term used to describe a structural element. In certain embodiments, the downtube is one of the strongest structural members on the frame, and the shock link fixed pivot is located in close proximity to the downtube to take advantage of its strength. In certain embodiments, the bottom bracket shell is part of a frame structure, and is structurally attached to a downtube and or frame support. In certain embodiments, the bottom bracket can be either directly or indirectly attached to the downtube or frame support.

In certain embodiments, the frame support can consist of a single sided strut that passes next to only one side of a shock absorber. In certain embodiments, a frame support can consist of a double sided strut that passes next to multiple sides of a shock absorber. In certain embodiments, a frame support can consist of a multiples struts that pass next to multiple sides of a shock absorber. In certain embodiments, a frame support can comprise a tubular member that can allow the fixed or sliding attachment of a seat post, where said seat post can be a component intended to fixture a seat for a rider in relation to the frame. In certain embodiments, a frame support can comprise a combination of a strut and a tubular member that can allow the fixed or sliding attachment of a seat post, where said seat post can be a component intended to fixture a seat for a rider in relation to the frame. In certain embodiments, a frame support can comprise a forged plate or bent tube that conforms around, below, above, or next to a shock absorber. In certain embodiments, a frame support passes next to a shock absorber and said frame support provides structural support for a downtube and bottom bracket shell.

In certain embodiments, a downtube can consist of a single sided strut that passes below one side of a shock absorber. In certain embodiments, a downtube can consist of a single sided strut that passes substantially below one side of a shock absorber. In certain embodiments, a downtube can consist of a single sided strut that passes above one side of a shock absorber. In certain embodiments, a downtube can consist of a single sided strut that passes substantially above one side of a shock absorber. In certain embodiments, a downtube can consist of a double sided strut that passes next to both sides of a shock absorber. In certain embodiments, a downtube can consist of a strut that passes next to both sides of and below a shock absorber. In certain embodiments, a downtube can consist of a combination of struts that pass next to both sides of and below a shock absorber. In certain embodiments, a downtube can consist of a strut that passes next to both sides of and above a shock absorber. In certain embodiments, a downtube can consist of a combination of struts that pass next to both sides of and above a shock absorber.

A bottom bracket shell provides a mounting location for drivetrain components. In certain embodiments, a bottom bracket shell provides a mounting location for a bicycle crank arm and sprocket assembly, where said sprocket is intended to rotate a chain which in turn rotates a rear wheel. In certain other embodiments, a bottom bracket shell can be the location of a transmission output sprocket, where said sprocket is intended to rotate a chain which in turn rotates a rear wheel. In certain embodiments, a bottom bracket shell can pass below a shock absorber. In certain embodiments, a bottom bracket shell can pass above a shock absorber. In certain embodiments, a bottom bracket shell can be in-line with a shock absorber. In certain embodiments a bottom bracket shell can comprise tabs suitable for mounting a first or second shock pivot. In certain embodiments a bottom bracket shell can comprise tabs suitable for mounting a bicycle chainguide. In certain embodiments a bottom bracket shell can comprise tabs suitable for mounting an impact protector.

A frame, frame support, or strut, in certain embodiments, may comprise a solid beam, a solid bar, a metal bar, a plastic bar, a composite bar, a tube, a metal tube, an aluminum tube, a titanium tube, a steel tube, a composite tube, a carbon tube, a boron tube, an alloy tube, a magnesium tube, a stiff tube, a flexible tube, a thin walled tube, a thick walled tube, a butted tube, a single butted tube, a double butted tube, a triple butted tube, a quadruple butted tube, a straight gage tube, a round tube, a square tube, a rectangular tube, a rounded corner tube, a shaped tube, an aero tube, a streamline tube, a plus shaped tube, a bat shaped tube, a tube that transitions from a round tube to a rectangular tube, a tube that transitions from a round tube to a square tube, a tube that transitions from a round tube to a rounded corner tube, a tube that transitions from a round tube to a shaped tube, welding, MIG welding, TIG welding, laser welding, friction welding, a welded tube, a TIG welded tube, a MIG welded tube, a laser welded tube, a friction welded tube, a monocoque section, a monocoque frame, metal monocoque, TIG welded monocoque, MIG welded monocoque, laser welded monocoque, friction welded monocoque, carbon monocoque, Kevlar monocoque, fiberglass monocoque, composite monocoque, fiberglass, carbon fiber, foam, honeycomb, stress skin, braces, extrusion, extrusions, metal inserts, rivets, screws, castings, forgings, CNC machined parts, machined parts, stamped metal parts, progressive stamped metal parts, tubes or monocoque parts welded to cast parts, tubes or monocoque parts welded to forged parts, tubes or monocoque parts welded to machined parts, tubes or monocoque parts welded to CNC machined parts, glue, adhesive, acrylic adhesive, methacrylate adhesive, bonded panels, bonded tubes, bonded monocoque, bonded forgings, bonded castings, tubes bonded to CNC machined parts, tubes bonded to machined parts, tubes bonded to castings, tubes bonded to forgings, gussets, supports, support tubes, tabs, bolts, tubes welded to tabs, monocoque welded to tabs, tubes bolted to tabs, injection molded parts, seatstays, chainstays, a seatstay, a chainstay, a seat tube, seat tower, seatpost, seat, top tube, upper tube, downtube, lower tube, top tubes, down tubes, seat tube brace, and/or a seat tube support.

### 5.13 Shock Absorbers of Suspension Systems of the Invention

A suspension system of the current invention, in certain embodiments, comprises a shock absorber, or two, three, four, five or more shock absorbers. A shock absorber, in certain embodiments, may be a damper, a spring, a compression gas spring, a leaf spring, a coil spring, or a fluid. A shock absorber, in certain embodiments may comprise a first shock pivot, a second shock pivot, a body, a shaft, a spring, an air spring, a gas spring, a bushing, a shaft axial movement, a shock length, a strut, and/or a piston. A shock absorber can be called a shock absorber, a shock, a spring damper unit, a spring, a damper, an energy converter, and/or a heat converter. In certain embodiments of the invention a shock absorber can be compressed or extended as the suspension moves towards a state of full compression. In certain embodiments, a shock absorber can be compressed at a constant or variable rate as the suspension moves towards a state of full compression. As a wheel is compressed, incremental vertical compression distance measurements are taken. Incremental vertical compression distance is measured perpendicular to gravity and a ground plane. These incremental vertical measurements are called the incremental vertical compression distance. A shock absorber length can be changed by a wheel link, and/or brake link, and/or control link movements as the suspension compresses. At each incremental vertical compression distance measurement, a shock absorber length measurement is taken. The relationship between incremental vertical compression distance change and shock absorber length change for correlating points in the suspension's compression can be called leverage ratio, leverage ratio, motion ratio or motion rate. A leverage ratio curve is a graphed quantifiable representation of leverage ratio versus wheel compression distance or percentage of full compression. Leverage ratios and creation of leverage ratio curves are discussed and shown specifically in Section 5.14 and FIGS. 3, 4, 5, 6, and 7. A shock absorber has a measured shock length. A shock length can also be called length and is measured as the shortest straight line distance between a first shock pivot and second shock pivot. A spring in a shock absorber can have a spring rate defined as the amount of force output at a given shock length. As a shock length is changed, spring force changes. This change can be graphed as spring rate. A spring found in a shock absorber can have a spring rate that varies or is constant as the shock absorber is compressed at a constant rate. In certain embodiments, a shock absorber of a suspension system of the invention is located below a control link floating pivot, a control link fixed pivot, a first shock pivot, and/or a second shock pivot, or any one or more of these components, of a suspension system according to the invention when the suspension is uncompressed and the bicycle is on even ground when even ground is perpendicular to gravity. In certain embodiments, a shock absorber of a suspension system of the invention is located above a wheel link floating pivot, a wheel link, a brake link, a wheel link fixed pivot, a control link fixed pivot, a control link floating pivot, a control link, a first shock pivot, a second shock pivot, and/or an instant force center, or any one or more of these components, of a suspension system according to the invention when the suspension is uncompressed and the bicycle is on even ground when even ground is perpendicular to gravity. In certain embodiments, a shock absorber of a suspension system of the invention is located in front of a control link floating pivot, a control link fixed pivot, a first shock pivot, and/or a second shock pivot, or any one or more of these components, of a suspension system according to the invention when the suspension is uncompressed and the bicycle is on even ground when even ground is perpendicular to gravity. In certain embodiments, a shock absorber of a suspension system of the invention is located behind a wheel link floating pivot, a wheel link, a brake link, a wheel link fixed pivot, a control link fixed pivot, a control link floating pivot, a control link, a first shock pivot, a second shock pivot, and/or an instant force center, or any one or more of these components, of a suspension system according to the invention when the suspension is uncompressed and the bicycle is on even ground when even ground is perpendicular to gravity. In certain embodiments, a shock absorber of a suspension system of the invention is compressed as the suspension is moved towards a point of full compression, where a first shock pivot moves in a rearward direction. In certain embodiments, a shock absorber of a suspension system of the invention is compressed as the suspension is moved towards a point of full compression, where a first shock pivot moves in a downward direction. In certain embodiments, a shock absorber of a suspension system of the invention is compressed as the suspension is moved towards a point of full compression, where a first shock pivot moves in a rearward and downward direction. In certain embodiments, a shock absorber of a suspension system of the invention is compressed as the suspension is moved towards a point of full compression, where a first shock pivot moves in a rearward and upward direction. In certain embodiments, a shock absorber of a suspension system of the invention is compressed as the suspension is moved towards a point of full compression, where a first shock pivot moves in a rearward and upward, then rearward and downward direction. In certain embodiments, a shock absorber can pass next to multiple sides of a frame support. In certain embodiments, a shock absorber can pass between multiple frame supports. In certain embodiments, a shock absorber can pass next to a frame support. In certain embodiments, a shock absorber can pass through a frame support. In certain embodiments, a shock absorber can pass through a tunnel, where said tunnel can comprise a frame support, a downtube, a bottom bracket shell, a strut. In certain preferred embodiments, a shock absorber passes above a bottom bracket shell.

In certain preferred embodiments, a shock absorber passes above a downtube. In certain embodiments, a shock absorber passes through a downtube. In certain embodiments, a shock absorber passes next to a downtube or plurality of downtubes. In certain embodiments, a shock absorber passes above and next to a downtube that is formed to conform around said shock absorber.

In certain embodiments, the frame support can consist of a single sided strut that passes next to only one side of a shock absorber. In certain embodiments, a frame support can consist of a double sided strut that passes next to multiple sides of a shock absorber. In certain embodiments, a downtube can consist of a single sided strut that passes substantially below only one side of a shock absorber. In certain embodiments, a downtube can consist of a double sided strut that passes next to both sides of a shock absorber. In certain embodiments, a downtube can consist of a strut that passes next to both sides of and below a shock absorber. In certain embodiments, a downtube can consist of a combination of struts that passes next to both sides of and below a shock absorber.

### 5.14 Leverage Ratio Curves of Suspension Systems of the Invention

A suspended wheel has a compressible wheel suspension travel distance that features a beginning travel point where the suspension is completely uncompressed to a point where no further suspension extension can take place, and an end travel point where a suspension is completely compressed to a point where no further suspension compression can take place. At the beginning of the wheel suspension travel distance, when the suspension is in a completely uncompressed state, the shock absorber is in a state of least compression, and the suspension is easily compressed. As the suspended wheel moves compressively, shock absorber force at the wheel changes in relation to shock absorber force multiplied by a leverage ratio, where a leverage ratio is the ratio of compressive wheel travel change divided by shock absorber measured length change over an identical and correlating given wheel travel distance. Shock absorbers can output an increase in force for a compression or extension movement depending on the design of the shock absorber. In certain embodiments of the invention a shock absorber is compressed or extended as the suspension moves towards a state of full compression. A leverage ratio curve is a graphed quantifiable representation of leverage ratio versus wheel compression distance or percentage of full compression. Wheel compression distance or vertical wheel travel is measured perpendicular to gravity with the initial 0 percent measurement taken at full suspension extension with the bicycle unladen and on even ground. As a suspension of the invention is compressed from a point of full extension to a point of full compression at a constant rate, measurements of shock absorber length are taken as the shortest distance between a first shock pivot and a second shock pivot at equal increments of shock absorber compression. When graphed as a curve on a Cartesian graph, leverage ratio is shown on the Y axis escalating from the x axis in a positive direction, and vertical wheel travel is shown on the X axis escalating from the Y axis in a positive direction. In certain embodiments, a shock absorber can be compressed at a constant or variable rate as the suspension moves towards a state of full compression. As a wheel is compressed, incremental vertical compression distance measurements are taken. Incremental vertical compression distance is measured perpendicular to gravity and a ground plane. These incremental vertical measurements are called the incremental vertical compression distance. A shock absorber length can be changed by a wheel link, and/or brake link, and/or control link movements as the suspension compresses. At each incremental vertical compression distance measurement, a shock absorber length measurement is taken. The relationship between incremental vertical compression distance change and shock absorber length change for correlating points in the suspension's compression can be called leverage ratio, leverage ratio, motion ratio or motion rate. The measurement of force output at the wheel over travel is called wheel rate and is found by multiplying spring force times leverage ratio at each increment of shock compression. Multiplying spring force times leverage ratio at each increment of shock compression and graphing the values will output a quantifiable representation of spring force output at the rear wheel as the suspension is compressed, and this representation is useful for a designer or engineer to tactically plan a desired wheel rate. A spring in a shock absorber can have a spring rate defined as the amount of force output at a given shock length. As a shock length is changed, spring force changes. This change can be graphed as spring rate. A spring found in a shock absorber can have a spring rate that varies or is constant as the shock absorber is compressed at a constant rate. This constant or variable spring rate can be manipulated into a desired wheel rate by a tactically planned leverage ratio. Leverage ratios of the current invention are designed to achieve a desired force output at a wheel. In certain embodiments a leverage ratio curve can be broken down into three equal parts in relation to wheel compression distance or vertical wheel travel, a beginning ⅓ (third), a middle ⅓, and an end ⅓. In certain embodiments, a beginning ⅓ can comprise a positive slope, zero slope, and or a negative slope. In certain embodiments, a middle ⅓ can comprise a positive slope, zero slope, and or a negative slope. In certain embodiments, an end ⅓ can comprise a positive slope, zero slope, and or a negative slope.

Certain preferred embodiments can comprise a beginning ⅓ with a positive slope, a middle ⅓ with a less positive slope, and an end ⅓ with a more positive slope.

Certain preferred embodiments can comprise a beginning ⅓ with a negative slope, a middle ⅓ with negative and zero slope, and an end ⅓ with a positive slope. Certain preferred embodiments can comprise a beginning ⅓ with a positive and negative slope, a middle ⅓ with negative and zero slope, and an end ⅓ with a positive slope.

Certain preferred embodiments can comprise a beginning ⅓ with a negative slope, a middle ⅓ with negative and positive slope, and an end ⅓ with a positive slope.

Certain preferred embodiments can comprise a beginning ⅓ with a negative slope, a middle ⅓ with negative and positive slope, and an end ⅓ with a negative slope.

Certain preferred embodiments can comprise a beginning ⅓ with a positive and negative slope, a middle ⅓ with negative and zero slope, and an end ⅓ with a more negative slope.

### 5.15 Further Embodiments of the Invention

A bicycle using a suspension of the invention may, in certain embodiments, comprise a measurable suspension parameter, a link length or link lengths measured from the center of one link pivot to another, bicycle metrics, a frame, a moving suspension component, a pivot, a rotary motion device, a motion control device, and/or a power-train component.

A measurable suspension parameter and bicycle metrics, in certain embodiments, may comprise a wheelbase, track width, camber, caster, anti squat, pro squat, zero squat, squat, rake, trail, offset, fork offset, spindle offset, chainstay length, swingarm length, distance between driven wheel rotation axis and power unit output spindle axis, chain length, belt length, bottom bracket, bottom bracket offset, drive spindle, drive spindle offset, drive spindle height, wheel diameter, driven wheel diameter, driven wheel spindle height, chainstay slope, chainstay rise, center of mass, center of mass height, center of mass offset, center of mass offset from drive spindle, length, magnitude, top tube length, downtube length, front center distance, seat tube length, seatstay length, headset stack height, head tube angle, fork angle, impact angle, fork rake, crown rake, handlebar height, bar height, bar sweep, handlebar sweep, handlebar rise, bar rise, crank length, crank arm length, pitch diameter, gear pitch diameter, sprocket pitch diameter, cog pitch diameter, front gear pitch diameter, front sprocket pitch diameter, front cog pitch diameter, rear gear pitch diameter, rear sprocket pitch diameter, rear cog pitch diameter, first intermediate gear pitch diameter, second intermediate gear pitch diameter, first intermediate sprocket pitch diameter, second intermediate sprocket pitch diameter, first intermediate cog pitch diameter, second intermediate cog pitch diameter, instant center, instant force center, center of curvature, axle path, axle path center of curvature, moving center of curvature, forward moving center of curvature, forward moving instant center, rearward moving instant center, instant center movement direction change, center of curvature path, instant center path, instant center path focus, moving instant center path focus, virtual force center, virtual instant force center, virtual force center path, driving force, chain force, anti rotation force, sprocket force, bevel gear force, rotational force, driving force vector, chain pull, chain pull force, chain pull force vector, idler gear height, idler gear pitch diameter, idler cog pitch diameter, idler sprocket pitch diameter, jackshaft gear pitch diameter, jackshaft cog pitch diameter, jackshaft sprocket pitch diameter, leverage ratio, leverage ratio, damper leverage ratio, damper leverage ratio, spring leverage ratio, spring leverage ratio, wheel motion ratio, wheel rate, spring rate, damping rate, leverage ratio progression curve, leverage ratio progression, progressive rate, regressive rate, straight rate, varying rate, suspension compression, full suspension compression, suspension extension, full suspension extension, droop travel, full droop travel, suspension ride height, static ride height, neighed ride height, laden ride height, weighted ride height, beginning of travel, middle of travel, end of travel, 0 percent travel to 20 percent travel, 20 percent travel to 80 percent travel, 80 percent travel to 100 percent travel, 0 percent travel to 25 percent travel, 25 percent travel to 75 percent travel, 75 percent travel to 100 percent travel, 0 percent travel to 30 percent travel, 30 percent travel to 65 percent travel, 65 percent travel to 100 percent travel, 0 percent travel to 35 percent travel, 35 percent travel to 60 percent travel, 60 percent travel to 100 percent travel, powertrain component rotation axis, driven wheel rotation axis, non driven wheel rotation axis, sprocket rotation axis, axis, axis location, rear wheel rotation axis, front wheel rotation axis, contact patch, tire contact patch, tire to ground contact patch, driven wheel tire to ground contact patch, non driven wheel tire to ground contact patch, front wheel tire to ground contact patch, rear wheel tire to ground contact patch, chain force vector, driving force vector, squat force vector, first carrier manipulation link force vector, second carrier manipulation link force vector, squat definition point, squat layout line, lower squat measurement definition line, measured squat distance, driven wheel axle path, driven wheel suspension travel distance, stable squat magnitude curve, defines a squat magnitude curve upper bound, a squat magnitude curve lower bound, instant force center, driven wheel rotation axis, chain force vector and driving force vector intersection point, driving cog rotation axis, center of the forward wheel tire to ground contact patch, center of the driven wheel tire to ground contact patch, bicycle center of sprung mass, 200 percent squat point, 200 percent measurement value, direction of gravity, squat magnitude definition point, squat magnitude, center of mass intersection vector, squat magnitude definition vector, percent squat magnitude variation, first squat magnitude curve slop; first squat magnitude curve slope, second squat magnitude curve slope, third squat magnitude curve slop; instant force center path, instant force center path focus, pitch diameter, driven idler cog rotation axis, instant force center position uncompressed, instant force center position compressed, instant force center movement, and/or an instant force center movement.

A moving suspension component of a suspension system of the invention, according to certain embodiments, may be comprised of a link, a wheel carrier link, a wheel carrier, a carrier manipulation link, an upper carrier manipulation link, lower carrier manipulation link, first carrier manipulation link, second carrier manipulation link, swingarm, swingarms, swinging arm, swinging arms, swing link, swing links, first link, second link, upper link, lower link, top link, bottom link, forward link, rearward link, front link, back link, primary link, secondary link, flexure, flexures, first flexure, second flexure, upper flexure, lower flexure, top flexure, bottom flexure, forward flexure, rearward flexure, front flexure, back flexure, primary flexure, secondary flexure, carrier manipulation flexures, sliders, curved sliders, straight sliders, complex curved sliders, carriers, tracks, curved tracks, straight tracks, complex curved tracks, bearings, cams, gears, seals, pivots, shock link, linkages, shock driving links, A-Arms, H-Arms, support arms, upper support, lower support, double arms, single arms, single pivot, multi pivot, SLA, Short Long Arm, hub carrier, wheel carrier, spindle, spindle carrier, wheel support, spindle support, trailing arm, semi-trailing arm, swingarm, double swingarm, parallel links, semi-parallel links, perpendicular links, strut, MacPherson strut, suspension strut, linear bearing, linear bushing, stanchion, fork, fork lower, 4-bar linkage, 5-bar linkage, 6-bar linkage, 7 bar linkage, 8 bar linkage, linkage, multi link, trackbar, panhard bar, watts link, watt link, ball joints, heim joint, radial joint, rotary joint, internal damper, external damper, enclosed damper, enclosed spring, caster block, camber block, caster wedge, driven wheel, bicycle chassis, first link fixed pivot, second link fixed pivot, first link floating pivot, second link floating pivot, driving cog, driven cog, forward wheel, driven idler cog, spring damper unit, first carrier manipulation track, second carrier manipulation track, first carrier manipulation slider, second carrier manipulation slider, first carrier manipulation slider pivot, second carrier manipulation slider pivot, stiffening link, and/or a stiffening linkage.

A pivot and a rotary motion devices of a suspension of the invention, according to certain embodiments, may be comprised of a pivot, a main pivot, a chainstay pivot, a seatstay pivot, an upper main pivot, a lower frame pivot, an upper frame pivot, a bottom frame pivot, a top frame pivot, a forward frame pivot, a rearward frame pivot, a front frame pivot, a rear frame pivot, a primary frame pivot, a secondary frame pivot, a tertiary frame pivot, a first frame pivot, a second frame pivot, a third frame pivot, a fourth frame pivot, combinations of pivots, bearing pivots, bushing pivots, bearings, bushings, seals, grease ports, greased pivots, oiled pivots, needle bearing pivots, journal bearing pivots, DU bearing pivots, plastic bushing pivots, plastic bearing pivots, a flexure, flexures, composite flexures, titanium flexures, aluminum flexures, steel flexures, aluminum pivot shafts, stainless steel pivot shafts, steel pivot shafts, titanium pivot shafts, plastic pivot shafts, composite pivot shafts, hardened bearing races, hardened pivot shafts, anodized pivot shafts, plated pivot shafts, coated pivot shafts, bearing caps, bearings seals, o-rings, o-ring seals, x-rings, and/or a x-ring seal.

A motion control device of a suspension of the invention, according to certain embodiments, may be comprised of a shock, a shock absorber, a spring damper unit, a damper, a spring, a coil spring, a leaf spring, a compression spring, an extension spring, an air spring, a nitrogen spring, a gas spring, a torsion spring, a constant force spring, a flat spring, a wire spring, a carbon spring, a negative spring, a positive spring, a progressive spring, multiple springs, stacked springs, springs in series, springs in parallel, springs separate from a damper unit, a damper unit, hydraulics, hydraulic pistons, hydraulic valves, air valves, air cans, gears, cams, a cam, a gear, noncircular gears, linear damper, rotary damper, vane damper, friction damper, poppet valve, compensation spring, negative spring, elastomer, rubber bumper, bumper, progressive bumper, hydraulic bottoming bumper, pressure compensation, heat compensation, oil, water, damping fluid, cooling fluid, shims, pressure, shaft, through shaft, eyelet, adjusters, compensator, hose, reservoir, remote reservoir, low speed adjuster, high speed adjuster, mid range adjuster, bypass circuit, foot valve, large bump adjuster, small bump adjuster, high velocity adjuster, low velocity adjuster, hydraulic ram, hydraulic piston, active suspension, and/or a microprocessor.

A drivetrain component of a suspension of the invention, according to certain embodiments, may be comprised of an energy storage device, a battery, fuel, a fuel tank, a flywheel, a liquid fuel, solid fuel, rocket fuel, a reactor, steam, a nuclear reactor, a fusion reactor, pressure, air pressure, hydraulic pressure, gas pressure, expanding gas, a motor, an electric motor, a hydraulic motor, a turbine motor, a steam turbine, a gas turbine motor, an engine, a gasoline engine, a diesel engine, diesel, gasoline, alcohol, sterling engine, a two stroke engine, a four stroke engine, miller cycle engine, ramjet engine, turbine engine, rocket engine, human power, horse power, animal power, potential energy, spring, compression spring, extension spring, constant force spring, progressive spring, power transfer components, wire, rope, string, chain, belt, shaft, gear, cog, cam, sprocket, pulley, lever, clutch, one way clutch, one way bearing, bearing, ball bearing, journal bearing, bushing, drive sprocket, driven sprocket, drive cog, driven cog, drive gear, driven gear, intermediate cog, intermediate sprocket, intermediate gear, idler cog, idler sprocket, idler gear, bottom bracket, bottom bracket spindle, crank arm, foot pedal, pedal, hand crank, cassette, sprocket cluster, derailleur, front derailleur, rear derailleur, chainguide, single ring chainguide, dual ring chainguide, multi ring chainguide, shifter, shift lever, shifter cable, shifter hose, hydraulic shifting, air shifting, pneumatic shifting, gearbox, transmission, continuously variable transmission, infinitely variable transmission, direct drive, tire, wheel, track, track segment, idler wheel, jet, driving cog, driven cog, forward wheel, driven idler cog.

Certain embodiments of the current invention may comprise a braking system which could further comprise disc brakes, calipers, disc caliper, hydraulic brakes, mechanical brakes, brake levers, brake hose, brake cable, brake pads, caliper brakes, rim brakes, V-brakes, cantilever brakes, friction brakes, wheel brake, mounting bolts, international brake standard mounting.

A suspension of the invention will comprise a linkage system which further comprise pivoting means concentric to a wheel rotation axis so that braking forces can be controlled by tactical placement of an instant force center, and so that acceleration forces can be controlled by the placement of a fixed pivot or pivots of a swinging wheel link.

The present invention is not to be limited in scope by the specific embodiments described herein, which are intended as single illustrations of individual aspects of the invention, and functionally equivalent methods and components are within the scope of the invention. Indeed, various modifications of the invention, in addition to those shown and described herein, will become apparent to those skilled in the art from the foregoing description. Such modifications are intended to fall within the scope of the appended claims. Throughout this application the singular includes the plural and the plural includes the singular, unless indicated otherwise. All cited publications, patents, and patent applications are herein incorporated by reference in their entirety.

What is claimed is:

1. A suspension system for a bicycle comprising a wheel link, a wheel rotation axis, a wheel link floating pivot, a rate link, a first shock pivot, a shock link, and a shock link fixed pivot, wherein said wheel link floating pivot and said rate link moves in a downward direction as the suspension is moved towards a point of full compression, and wherein said first shock pivot moves in a rearward and downward direction.

2. A suspension system for a bicycle comprising a wheel link, a wheel rotation axis, a wheel link floating pivot, a rate link, a first shock pivot, a shock link, and a shock link fixed pivot, wherein said wheel link floating pivot and said rate link moves in a downward direction as the suspension is moved towards a point of full compression, and wherein said first shock pivot moves in a rearward and upward, then rearward and downward direction.
